(19) United States
(12) Patent Application Publication
(10) Pub. No.: US 2019/0283511 A1
(43) Pub. Date: Sep. 19, 2019

(54) WHEEL ASSEMBLY

(71) Applicant: Honda Motor Co., Ltd., Tokyo (JP)

(72) Inventor: Michael Anthony Pearl, Anniston, AL (US)

(21) Appl. No.: 15/921,115

(22) Filed: Mar. 14, 2018

(51) Int. Cl. B60C 29/02; B60B 3/02; B62D 43/00

(52) U.S. Cl. CPC B60C 29/02; B60B 3/02; B62D 43/08; B62D 43/002; B62D 43/00

(57) ABSTRACT

A spare wheel assembly for a vehicle is provided. The spare wheel assembly includes a wheel rim including a first side and a second side, wherein the wheel rim further includes a first valve stem opening defined within the first side and a second valve stem opening defined within the second side. The spare wheel assembly also includes a pneumatic tire mounted on the wheel rim.

### BACKGROUND

The embodiments described herein relate generally to a spare wheel assembly provided on or within a vehicle, for use should one of the vehicle's main tires be damaged or become inoperable during use of the vehicle.

Known vehicles, for example, automobiles, trucks, tractors, and/or trailers, are provided with one or more spare wheel assemblies for use in the event that a main tire of the vehicle is damaged (e.g., goes flat). Typically, the spare wheel assembly is positioned on or within the vehicle in a manner that minimizes the amount of usable space in the vehicle occupied by the spare wheel assembly. For example, the spare wheel assembly may be carried under the vehicle, that is, held against an exterior surface of the vehicle's floor pan by a retention device. Known retention devices include a hoist. The hoist includes a cable, coupled at a first end to a rotatable member and configured to be wrapped around the rotatable member, and a bracket coupled to the opposite, second end of the cable. Rotating the rotatable member causes the bracket to be raised and lowered, and when removably coupled to the spare wheel assembly, causes the spare wheel assembly to be raised and lowered.

Spare wheel assemblies that include a pneumatic tire include a valve stem used to check the air pressure within the tire and to add or remove air from within the tire. On vehicles that include a spare wheel assembly carried under the vehicle, the spare wheel assembly may need to be lowered in order to access the valve stem.

### BRIEF DESCRIPTION

In one aspect, a spare wheel assembly for a vehicle is provided. The spare wheel assembly includes a wheel rim including a first side and a second side, wherein the wheel rim further includes a first valve stem opening defined within the first side and a second valve stem opening defined within the second side. The spare wheel assembly also includes a pneumatic tire mounted on the wheel rim.

In another aspect, a wheel rim is provided. The wheel rim includes a rim portion and a disc portion coupled to the rim portion and defining a first side of the rim portion and a second side of the rim portion. The wheel rim also includes a first valve stem opening defined within the first side of the rim portion and a second valve stem opening defined within the second side of the rim portion.

### BRIEF DESCRIPTION OF THE DRAWINGS

FIG. 1 is a perspective view of an exemplary embodiment of a spare wheel assembly for a vehicle.

FIG. 2 is a cross-section view of the spare wheel assembly shown in FIG. 1.

FIG. 3 is a perspective view of the spare wheel assembly shown in FIG. 1 and a first spare wheel assembly securing apparatus.

FIG. 4 is a perspective view of an exemplary cable and bracket that may be included in the first spare wheel assembly securing apparatus shown in FIG. 3.

FIG. 5 is a perspective view of the spare wheel assembly shown in FIG. 1 and a second spare wheel assembly securing apparatus.

FIG. 6 is a perspective view of the spare wheel assembly shown in FIG. 1 and a third spare wheel assembly securing apparatus.

### DETAILED DESCRIPTION

Implementations of the apparatus described herein facilitate checking air pressure, removing air, and/or adding air to a pneumatic tire on a spare wheel assembly secured on or within a vehicle without removing the spare wheel assembly or loosening a spare wheel assembly securing apparatus. More specifically, the spare wheel assembly described herein includes a first valve stem on a first side of the wheel assembly, and a second valve stem on the opposite, second side of the wheel assembly. By including the first and second valve stems on the spare wheel assembly in this orientation, one of the two valve stems can be accessed without removing or loosening the spare wheel assembly securing apparatus.

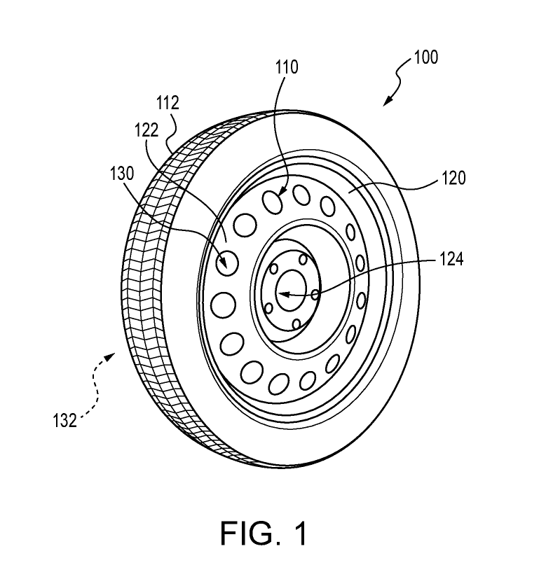

FIG. 1 is a perspective view of an exemplary embodiment of a spare wheel assembly 100 for a vehicle. In the exemplary embodiment, spare wheel assembly 100 is provided on or within the vehicle for use in the event that a main tire of the vehicle is damaged (e.g., goes flat). The vehicle may include two or more main tires, that is, tires that are being used to support the weight of the vehicle. The vehicle may include an automobile, truck, tractor, trailer, recreational vehicle, and/or any other type of vehicle that includes a spare wheel assembly.

Wheel assembly 100 includes a wheel rim 110 and a tire, for example, a pneumatic tire 112, mounted on the wheel rim 110. Wheel rim 110 includes a rim portion 120 and a disc portion 122. Rim portion 120 is cylindrical and configured to support and seal tire 112 to wheel rim 110. Disc portion 122 connects rim portion 120 to a wheel hub (not shown in FIG. 1) of the vehicle. A center opening 124 is defined within disc portion 122 configured to receive a portion of the wheel hub to couple wheel assembly 100 to the vehicle.

Wheel assembly 100 includes a first side 130 and a second side 132. As illustrated in FIG. 1, first side 130 is the side of wheel assembly 100 that would be visible to an observer viewing a side of the vehicle (e.g., when looking at the exterior of the vehicle and/or approaching the vehicle before entering the vehicle) when wheel assembly 100 is installed on the wheel hub of the vehicle. Furthermore, second side 132 is the side of wheel assembly 100 that would face a center of the vehicle when wheel assembly 100 is installed on the wheel hub. Wheel opening 124 extends between first side 130 and second side 132.

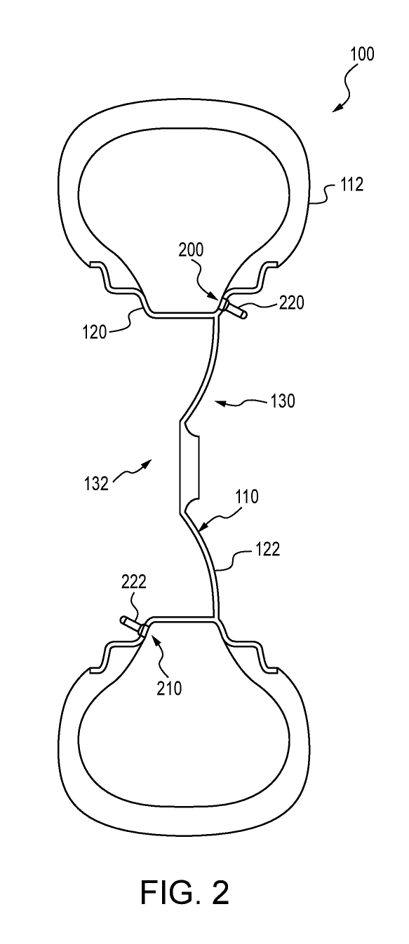

FIG. 2 is a cross-section view of the wheel assembly 100 shown in FIG. 1. A first opening 200 and a second opening 210 are defined within wheel rim 110 and configured to receive valve stems. For example, a first valve stem 220 is positioned at least partially within first opening 200 and a second valve stem 222 is positioned at least partially within second opening 210. Known methods may be used to couple valve stems 220 and 222 to wheel rim 110. First opening 200 is positioned within first side 130 of wheel assembly 100. First valve stem 220 is configured to extend from first side 130 of wheel assembly 100 facilitating accessing first valve stem 220 from first side 130 of wheel assembly 100. Second opening 210 is positioned within second side 132 of wheel assembly 100. Second valve stem 222 is configured to extend from second side 132 of wheel assembly 100 facilitating accessing second valve stem 222 from second side 132 of wheel assembly 100. By including a valve assembly on first side 130 and second side 132 of wheel assembly 100, air pressure within tire 112 can be measured and air can be added or removed from tire 112 from either first side 130 or second side 132.

Since second side 132 of wheel assembly 100 faces toward a center of the vehicle when wheel assembly 100 is installed on the wheel hub of the vehicle, second valve stem 222 is configured to prevent contact with vehicle components, for example, but not limited to, vehicle structural components, brake components, and/or suspension components. For example, in an exemplary embodiment, second valve stem 222 may be shorter than first valve stem 220 (i.e., second valve stem 222 extends a smaller distance from rim portion 120 than first valve stem 220). Alternatively, or in combination, second valve stem 222 may be recessed within rim portion 120 but still accessible from second side 132. Moreover, second valve stem 222 may extend from rim portion 120 at an angle closer to parallel with the ground when installed on the vehicle as a main tire than first valve stem 220.

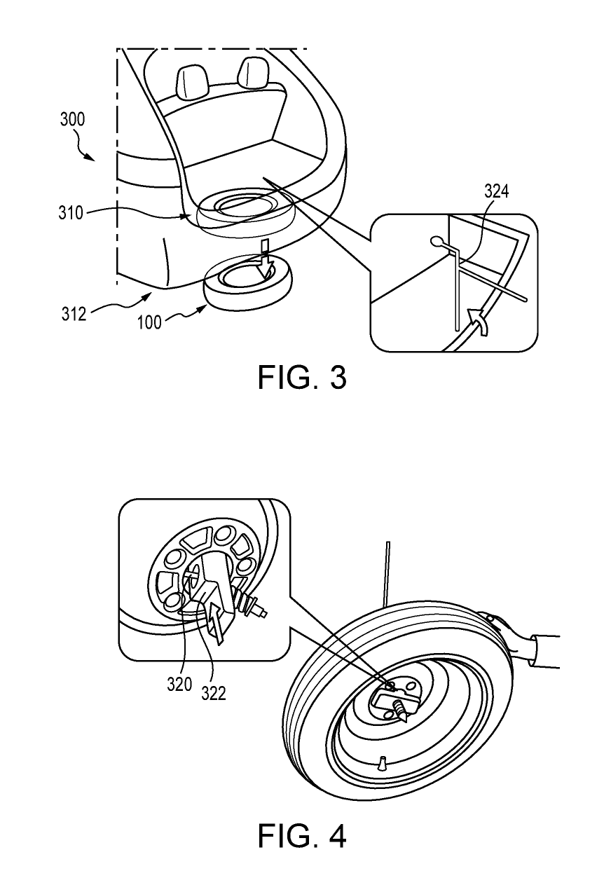

FIG. 3 is a perspective view of wheel assembly 100 and a first spare wheel assembly securing apparatus 300. First spare wheel assembly securing apparatus 300 secures wheel assembly 100 in a position under the vehicle. For example, spare wheel assembly securing apparatus 300 may hold wheel assembly 100 against an external surface of a lower body panel of the vehicle. As illustrated in FIG. 3, in a first position 310, wheel assembly 100 is held against the lower body panel of the vehicle. In a second position 312, wheel assembly 100 is lowered toward the ground and can be disconnected from the vehicle in order to be used.

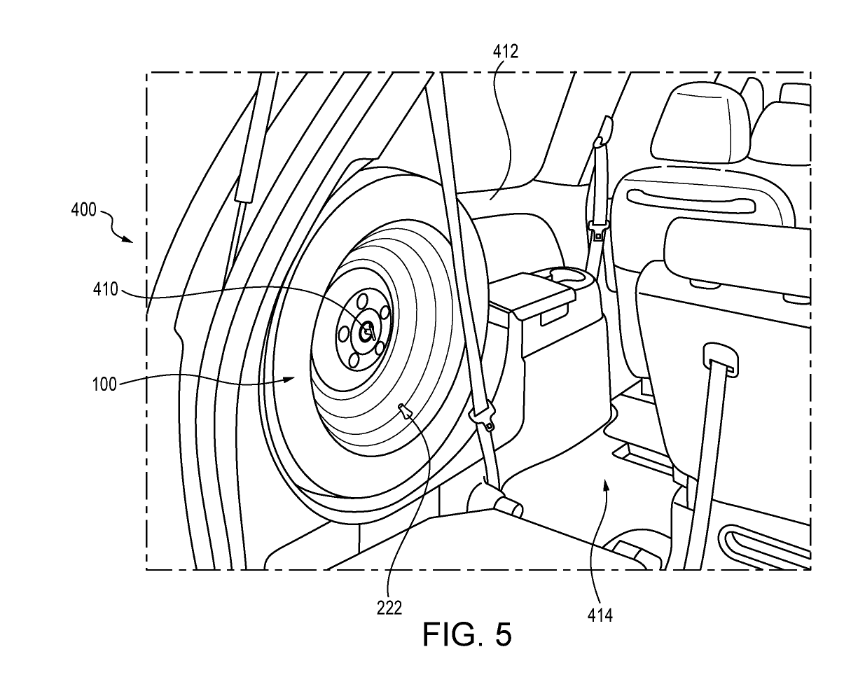

FIG. 4 is a perspective view of an exemplary cable and bracket that may be included in the first spare wheel assembly securing apparatus 300 shown in FIG. 3. First spare wheel assembly securing apparatus 300 may include a winch that includes a drum (not shown) and a cable 320. A bracket 322 is coupled to cable 320. Bracket 322 is inserted through center opening 124 and a tool 324 is used to rotate the drum. As the drum is rotated, more of cable 320 is wrapped around the drum, pulling bracket 322 and wheel assembly 100 toward the vehicle. The drum is rotated until the wheel assembly 100 is held securely against the exterior surface of the lower body panel.

In the illustrated embodiment, bracket 322 is inserted through center opening 124 from first side 130 toward second side 132. By inserting bracket 322 in this direction, first side 130 is held against the exterior surface of the lower body panel, and second side 132 faces the ground. This positioning is beneficial in that it protects the first side 130 (i.e., the side of wheel assembly 110 that will be visible when wheel assembly 110 is positioned for use on the vehicle) from environmental elements that may affect the appearance of wheel rim 110. For example, in this position, first side 130 is protected from rocks, dirt, and/or water that may contact wheel assembly 100 while wheel assembly 100 is positioned under the vehicle. Moreover, in this position, first valve stem 220 (shown in FIG. 2) is not accessible. However, second valve stem 222 is accessible. Second valve stem 222 allows wheel assembly 100 to be positioned in a desirable orientation with respect to the vehicle, while allowing air pressure measurement, adding, and/or removing air from tire 112 without lowering wheel assembly 100 from the first position 310 to the second position 312.

FIG. 5 is a perspective view of wheel assembly 100 and a second spare wheel assembly securing apparatus 400. Second spare wheel assembly securing apparatus 400 includes a threaded fastening device 410 that removably couples wheel assembly 100 to a side interior wall 412 of the vehicle. More specifically, first side 130 of wheel assembly 100 is held against the interior wall 412 of the vehicle, and second side 132 is accessible from an interior 414 of the vehicle. In this position, first valve stem 220 (shown in FIG. 2) is not accessible. However, second valve stem 222 is accessible.

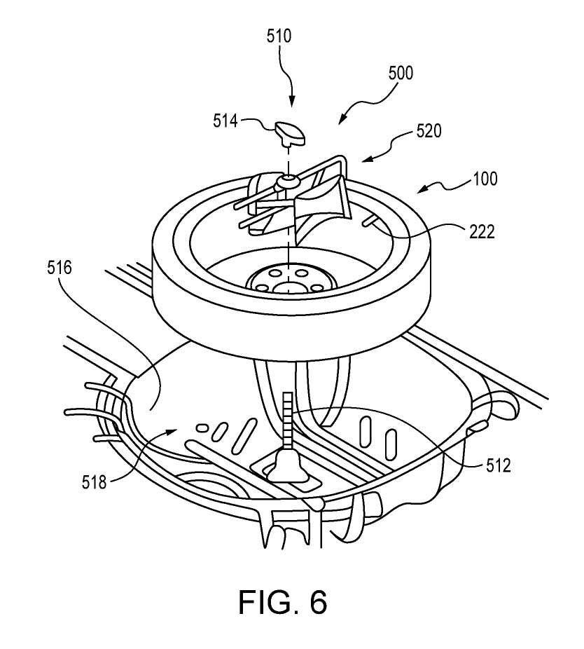

FIG. 6 is a perspective view of wheel assembly 100 and a third spare wheel assembly securing apparatus 500. Third spare wheel assembly securing apparatus 500 includes a threaded fastening device 510. Threaded fastening device 510 includes a threaded stud 512 and a corresponding threaded nut 514. In the exemplary embodiment, threaded nut 514 has a winged design allowing a user to tighten and loosen nut 514 without using a tool. In contrast to threaded fastening device 410 (shown in FIG. 5) that fastens wheel assembly 100 to side interior wall 412, threaded fastening device 510 removably couples wheel assembly 100 to an interior surface 516 of a floor panel 518 located in a trunk of the vehicle. As with second spare wheel assembly securing apparatus 400, third spare wheel assembly securing apparatus 500 secures wheel assembly 100 with first side 130 of wheel assembly 100 held against the interior surface 516. As shown in FIG. 6, positioning wheel assembly 100 in this manner facilitates placing something, for example, a jack and/or tools 520, in an open space in second side 132 of wheel assembly 100. In this position, first valve stem 220 (shown in FIG. 2) is not accessible. However, second valve stem 222 is accessible. Second valve stem 222 allows wheel assembly 100 to be positioned in a desirable orientation with respect to the vehicle, while allowing air pressure measurement, adding, and/or removing air from tire 112 without uncoupling wheel assembly 100 from the vehicle.

Described herein are exemplary embodiments of a wheel assembly that includes two valve stems. More specifically, the wheel assemblies described herein include a first valve stem on a first side of the tire, and a second valve stem on the opposite, second side of the tire. By including the first and second valve stems on the spare tire in this orientation, one of the two valve stems can be accessed without removing or loosening the spare wheel assembly securing apparatus. The wheel assemblies described herein facilitate ergonomic, efficient, and economical verification of spare tire air pressure and/or adding or removing air from the spare tire. Although the embodiments described herein are specific to tubeless tires, the concept of a wheel assembly having two valve stems is applicable to a tire that includes an inner tube. In such an alternative embodiment, the inner tube includes two valve stems configured to align with openings, for example, openings 200 and 210 (shown in FIG. 2), within a wheel rim, for example, wheel rim 110 (shown in FIG. 2).

When introducing elements/components/etc. of the apparatus described and/or illustrated herein, the articles “a”, “an”, “the”, and “said” are intended to mean that there are one or more of the element(s)/component(s)/etc. The terms “comprising”, “including”, and “having” are intended to be inclusive and mean that there may be additional element(s)/component(s)/etc. other than the listed element(s)/component(s)/etc.

This written description uses examples to provide details on the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A spare wheel assembly for a vehicle comprising:
a wheel rim including a first side and a second side, wherein said wheel rim further includes a first valve stem opening defined within said first side and a second valve stem opening defined within said second side; and
a pneumatic tire mounted on said wheel rim.

2. The spare wheel assembly of claim 1 further comprising a first valve stem positioned at least partially within said first valve stem opening and a second valve stem positioned at least partially with said second valve stem opening.

3. The spare wheel assembly of claim 2, wherein said first valve stem and said second valve stem are configured to facilitate checking an air pressure within said pneumatic tire.

4. The spare wheel assembly of claim 2, wherein said first valve stem and said second valve stem are configured to facilitate adding and removing air from said pneumatic tire.

5. The spare wheel assembly of claim 2, wherein said first valve stem extends from said wheel rim a greater amount than said second valve stem.

6. The spare wheel assembly of claim 2, wherein said second valve stem is recessed within said second valve stem opening.

7. The spare wheel assembly of claim 1, wherein said first side is a side of said wheel rim that faces outward from the vehicle when said spare wheel assembly is coupled to a vehicle wheel hub for use as a vehicle tire.

8. The spare wheel assembly of claim 1, wherein said wheel rim further includes a center opening defined therein extending between said first side and said second side.

9. The spare wheel assembly of claim 8, wherein said center opening is configured to receive at least one of a bracket and a threaded stud of a spare wheel assembly securing apparatus.

10. The spare wheel assembly of claim 9, wherein said spare wheel assembly securing apparatus is configured to removably couple the spare wheel assembly to a portion of the vehicle.

11. The spare wheel assembly of claim 10, wherein the portion of the vehicle comprises at least one of an interior surface of a rear body panel, an interior surface of a trunk panel, and an exterior surface of a vehicle body pan.

12. A wheel rim comprising:
a rim portion;
a disc portion coupled to said rim portion and defining a first side of said rim portion and a second side of said rim portion;
a first valve stem opening defined within said first side of said rim portion; and
a second valve stem opening defined within said second side of said rim portion.

13. The wheel rim of claim 12 further comprising a first valve stem positioned at least partially within said first valve stem opening and a second valve stem positioned at least partially with said second valve stem opening.

14. The wheel rim of claim 13, wherein said first valve stem and said second valve stem are configured to facilitate checking an air pressure within a pneumatic tire mounted on said wheel rim, and adding and removing air from said pneumatic tire.

15. The wheel rim of claim 13, wherein said first valve stem extends from said rim portion a greater amount than said second valve stem.

16. The wheel rim of claim 12, wherein said first side is a side of said wheel rim that faces outward from the vehicle when said wheel rim is coupled to a vehicle wheel hub for use as a vehicle tire.

17. The wheel rim of claim 12, wherein said disc portion further comprises a center opening defined therein extending between said first side and said second side.

18. The wheel rim of claim 17, wherein said center opening is configured to receive at least one of a bracket and a threaded stud of a spare wheel assembly securing apparatus.

19. The wheel rim of claim 18, wherein said spare wheel assembly securing apparatus is configured to removably couple said wheel rim to a portion of the vehicle.

20. The wheel rim of claim 19, wherein the portion of the vehicle comprises at least one of an interior surface of a rear body panel, an interior surface of a trunk panel, and an exterior surface of a vehicle body pan.
